(19) United States
(12) Patent Application Publication
(10) Pub. No.: US 2018/0024600 A1
(43) Pub. Date: Jan. 25, 2018

(54) ELECTRONIC DEVICE AND ELECTRONIC APPARATUS

(71) Applicant: LENOVO (SINGAPORE) PTE. LTD., Singapore (SG)

(72) Inventor: YASUHIRO HORIUCHI, YOKOHAMA (JP)

(73) Assignee: LENOVO (SINGAPORE) PTE. LTD., Singapore (SG)

(21) Appl. No.: 15/642,492

(22) Filed: Jul. 6, 2017

(30) Foreign Application Priority Data
Jul. 25, 2016 (JP) 2016145493

(51) Int. Cl. G06F 1/20

(52) U.S. Cl. CPC G06F 1/20; G06F 2200/203

(57) ABSTRACT

A screw hole which is formed on one end of a substrate and through which an electronic device is attached to a metal frame by using a metal screw provided, an NAND memory as a heating section is provided on the screw hole side, a heat conducting sheet which covers an upper peripheral portion of the screw hole and an upper portion of the NAND memory is provided, and heat of the NAND memory is conducted to the metal frame through the heat conducting sheet and the metal screw fitted into the screw hole.

### FIELD OF THE INVENTION

The present invention relates to an electronic device and an electronic apparatus each of which has a simple structure and can suppress temperature rise of a heating section of an SSD or the like.

### BACKGROUND OF THE INVENTION

In recent years, in place of a hard disk drive, an SSD (solid state drive) device having a high throughput speed is used. For example, Patent Document 1 describes that, in an audio network storage, to eliminate a motor driving section which is a noise source at the time of reproducing audio data, the SSD is used as a memory device of the storage, and a metal chassis having a high radiation effect is adopted. Thus, the SSD can be sealed without mounting a cooling fan, thereby suppressing noise generation due to an interference with a power source section or the like.

[Patent Document 1] Japanese Patent Application Laid-Open No. 2011-158744

### SUMMARY OF THE INVENTION

Meanwhile, since NAND memory devices are arranged with high density, the SSD is apt to have a high temperature depending on a processing operation and, for example, approximately 85° C. or less is an operation allowing temperature. To prevent the SSD itself from having a high temperature, performance of a CPU using the SSD is automatically lowered. In particular, at the time of a device rise, continuous access is carried out, a temperature of the NAND memory devices rapidly increases, processing to lower the performance to, e.g., approximately 20% is repeated so that the NAND memory devices can have the operation allowing temperature or less, and hence a device rise time becomes long.

In view of the above description, it is an object of the present invention to provide an electronic device and an electronic apparatus which can suppress an increase in temperature of a heating section such as an SSD by using a simple structure.

To solve the above problem and to achieve the object, an electronic device according to the first aspect of the present invention includes: a substrate having a predetermined shape and a screw hole on a first end side of the substrate, the screw hole being used for attaching the electronic device to a metal frame by using a metal screw; a heating section arranged on the substrate, the heating section being close to the screw hole; a heat conducting sheet which covers an upper peripheral portion of the screw hole and an upper portion of the heating section. Also, heat of the heating section is configured to be conducted to the metal frame through the heat conducting sheet and the metal screw fitted into the screw hole.

Further, a second end side of the substrate may have a connector terminal connected to an electronic apparatus to which the electronic device is attached.

Further, the heat conducting sheet may be made of carbon graphite.

Further, a label indicating the electronic device may be provided on an upper surface of the heat conducting sheet.

Further, the electronic device may be an SSD device, and the heating section on the first end side of the substrate may be an NAND memory, and a memory controller may be arranged on the second end side of the substrate.

Further, an electronic apparatus according to the second aspect of the present invention includes the electronic device; a metal frame to which the electronic device is attached; and a metal screw which attaches the electronic device to the metal frame through a screw hole.

According to the above-described aspects, since the heat conducting sheet which covers the upper peripheral portion of the screw hole and the upper portion of the heating section is provided and the heat of the heating section is conducted to the metal frame through the heat conducting sheet and the metal screw fitted into the screw hole, an increase in temperature of the heating section such as an SSD can be suppressed by using the simple structure, and a decrease in performance in continuous access at the time of a device rise or the like can be suppressed.

### BRIEF DESCRIPTION OF THE DRAWINGS

FIG. 1 is a plan view showing a configuration of an electronic device according to an embodiment;

FIG. 2 is a cross-sectional view taken along a line A-A of the electronic device shown in FIG. 1;

FIG. 3 is a cross-sectional view showing a state where the electronic device is attached to a metal frame in a chassis of an electronic apparatus such as a laptop PC;

FIG. 4 is a view showing a connection state near a screw hole;

FIG. 5 is a view showing an example where a label indicating the electronic device is provided on an upper surface of a heat conducting sheet; and

FIG. 6 is a view showing temporal changes in temperature rise of an NAND memory and temporal changes in performance of a CPU at the time of a device rise when a heat radiating mechanism using the heat conducting sheet is provided and when the same is not provided.

### DETAILED DESCRIPTION OF THE INVENTION

A mode for carrying out the present invention will now be described hereinafter with reference to the accompanying drawings.

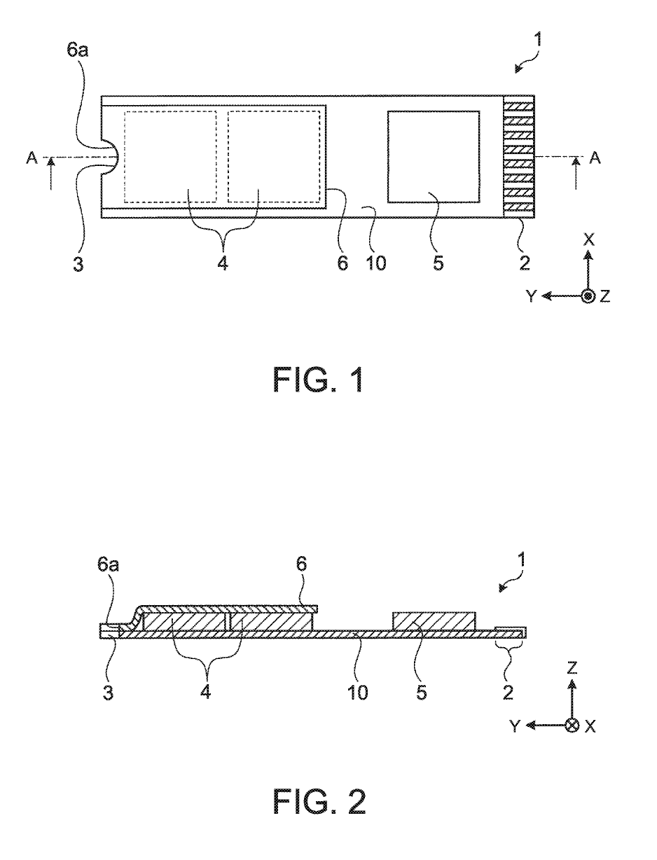

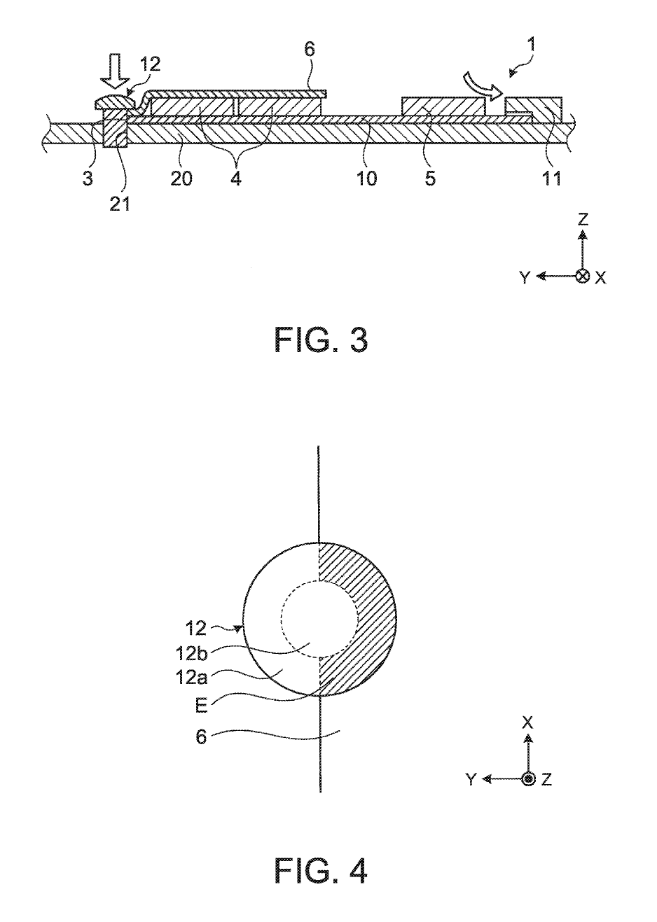

FIG. 1 is a plan view showing a configuration of an electronic device 1 according to an embodiment. Further, FIG. 2 is a cross-sectional view taken along a line A-A of the electronic device 1 depicted in FIG. 1. Furthermore, FIG. 3 is a cross-sectional view showing a state where the electronic device 1 is attached to a metal frame in a chassis of an electronic apparatus such as a laptop PC. It is to be noted that the electronic device 1 is an SSD device including SSD memories.

As shown in FIG. 1 to FIG. 3, in the electronic device 1, NAND memories 4 as heating sections are arranged on one end side (a Y direction side) on a substrate 10, and a memory controller 5 is arranged on the other end side of the same. At the one end of the substrate 10, a screw hole 3 into which a metal screw 12 to fix the electronic device to a metal frame 20 is fitted is formed. Moreover, at the other end of the substrate 10, a connector terminal 2 to connect the electronic device 1 to a CPU or the like in an electronic apparatus is formed. The connector terminal 2 is connected when it is inserted into a connector 11 formed on the metal frame 20. This electronic device 1 meets the M.2 standard which is a standard for a built-in expansion card of a computer.

An upper peripheral portion of the screw hole 3 and upper portions of the NAND memories 4 are covered with a heat conducting sheet 6. The heat conducting sheet 6 is bonded to the upper surfaces of the NAND memories 4. The heat conducting sheet 6 is made of aluminum or carbon graphite having high thermal conductivity. A hole 6a corresponding to the screw hole 3 is formed in the heat conducting sheet 6 on the screw hole 3 side. As shown in FIG. 3 and FIG. 4, in a state where the connector terminal 2 is inserted into the connector 11, when a shaft 12b of the metal screw 12 is fitted into the hole 6a and the screw hole 3 and the metal screw 12 is screwed to a threading 21 formed in the metal frame 20, the heat conducting sheet 6 and the substrate 10 are pressed toward the metal frame 20 by a head portion 12a of the metal screw 12. Consequently, the electronic device 1 is fixed to the metal frame 20.

As shown in FIG. 4, an upper peripheral portion E of the screw hole 3 is a region with which a lower surface of the head portion 12a of the metal screw 12 is in contact. In this upper peripheral portion E, the lower surface of the head portion 12a is in contact with an upper surface of the heat conducting sheet 6. Consequently, a heat conducting route between the NAND memories 4 and the metal frame 20 is formed through the heat conducting sheet 6 and the metal screw 12. That is, the heat of the NAND memories 4 is conducted to the metal frame 20 which functions as a heat sink through the heat conducting sheet 6 and the metal screw 12.

It is to be noted that the heat conducting sheet 6 is preferably made of carbon graphite. That is because the carbon graphite has high thermal conductivity in the Y direction.

Further, the memory controller 5 also generates heat, but it has an operation allowing temperature higher than that of the NAND memories 4, and hence the heat radiating mechanism is not provided to the memory controller 5. For example, the operation allowing temperature of the NAND memories 4 is 85° C., and the operation allowing temperature of the memory controller 5 is 125° C.

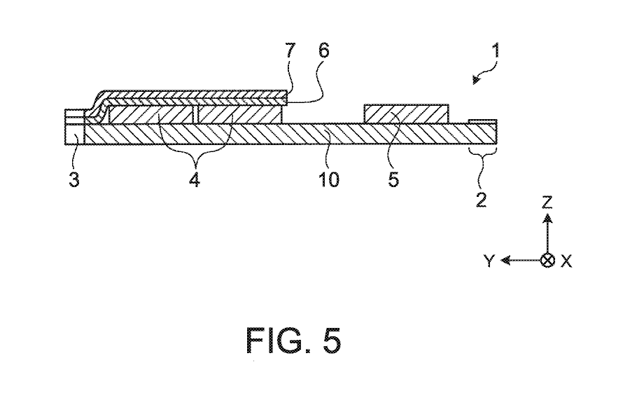

It is to be noted that, as shown in FIG. 5, a sheet-like label 7 formed of a PET (polyethylene terephthalate) resin or the like may be bonded to the upper surface of the heat conducting sheet 6. It is preferable to effect predetermined printing indicating the electronic device 1 or the like on an upper surface of this label 7 and bond the heat conducting sheet 6 to a lower surface of the same so that they can be integrally formed.

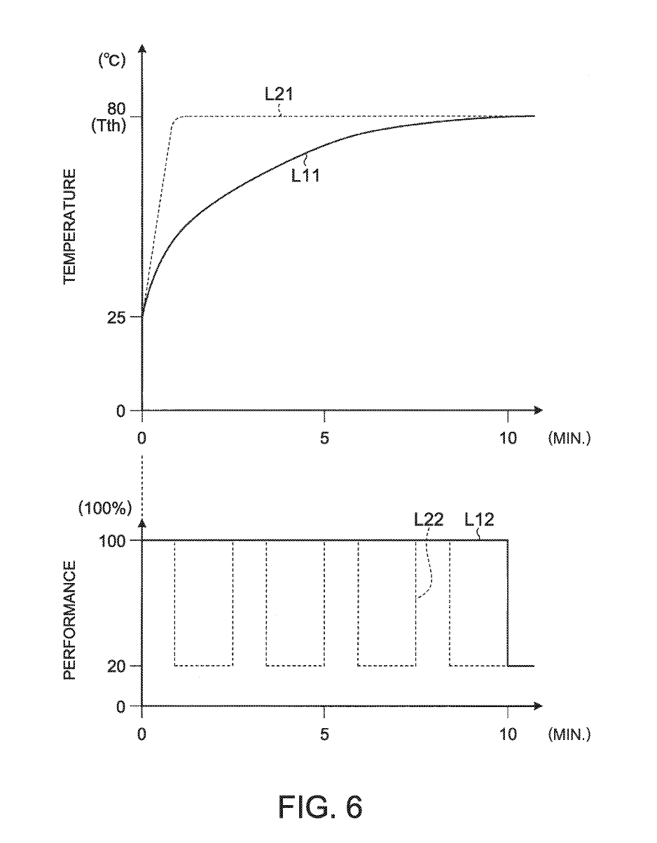

FIG. 6 is a view showing temporal changes in temperature rise of the NAND memory 4 and temporal changes in performance of the CPU at the time of a device rise when the heat radiating mechanism using the heat conducting sheet 6 is provided and when the same is not provided. It is to be noted that the operation allowing temperature of the NAND memory 4 is 85° C., but a margin of 5° C. is taken, and an operation allowing temperature Tth is set to 80° C.

As shown in FIG. 6, in a characteristic L21 of a change in temperature at the device rise when the heat conducting sheet 6 is not provided, 80° C. is reached in approximately one minute, and the performance of the CPU is decreased from 100% to ⅕, i.e., 20% at this moment as indicated by a characteristic L22. This decrease in performance causes a drop in temperature of the NAND memory 4, and hence the performance is again increased to 100%, but processing to again decrease the performance to 20% is repeated due to an increase in temperature of the NAND memory 4.

On the other hand, in a characteristic L11 of a change in temperature at the device rise when the heat conducting sheet 6 is provided, 80° C. is reached after approximately 10 minutes, and the performance of the CPU is decreased from 100% to 20% at this moment as indicated by a characteristic L12.

Thus, when the heat conducting sheet 6 is provided, the performance of the CPU is 100% until approximately 10 minutes pass, and the device rise is effected quickly as compared with the case where the heat conducting sheet 6 is not provided. Furthermore, even after 10 minutes, since the time required for decreasing the performance to 20% is shorter when the heat conducting sheet 6 is provided, a reduction in throughput speed of the device is small.

We claim:

1. An electronic device comprising:
a substrate having a predetermined shape and a screw hole on a first end of the substrate, wherein the screw hole is used for attaching the electronic device to a metal frame by using a metal screw;
a heating section arranged on the substrate, wherein the heating section is close to the screw hole;
a heat conducting sheet which covers an upper peripheral portion of the screw hole and an upper portion of the heating section;
wherein heat from the heating section is to be conducted to the metal frame through the heat conducting sheet and the metal screw in the screw hole.

2. The electronic device according to claim 1,
wherein a second end of the substrate has a connector terminal for connection to an electronic apparatus to which the electronic device is attached.

3. The electronic device according to claim 1,
wherein the heat conducting sheet is made of carbon graphite.

4. The electronic device according to claim 1,
wherein a label indicating the electronic device is provided on an upper surface of the heat conducting sheet.

5. The electronic device according to claim 1,
wherein the electronic device is an SSD device, and the heating section on the first end of the substrate is an NAND memory, and a memory controller is arranged on a second end of the substrate.

6. An electronic apparatus comprising:
the electronic device according to claim 1,
a metal frame to which the electronic device is attached; and
a metal screw which disposes the electronic device to the metal frame through the screw hole.
